(19) United States
(12) Patent Application Publication
(10) Pub. No.: US 2010/0035205 A1
(43) Pub. Date: Feb. 11, 2010

(54) Non-90-Degree Ergonomically-Shaped Dental Prophylaxis Angle with a Straight Driving Shaft

(76) Inventors: Daniel Wang, Roland Height, CA (US); Jianping Shen, Los Angeles, CA (US); Yong Zhu, Suzhou (CN)

Correspondence Address: Daniel Wang, 21078 Commerce Pointe Drive, Walnut, CA, 91789, US

(21) Appl. No.: 12/189,152

(22) Filed: Aug. 9, 2008

(51) Int. Cl. A61C 1/12

(52) U.S. Cl. 433/133

(57) ABSTRACT

A disposable dental angle with a one-piece hollow housing, having the axis of its head section angled obtusely with respect to the axis of its tail section, is provided. The obtusely angled front aperture of the head section of the housing allows insertion of a driven rotor such that the driven rotor is positioned with an obtuse angle to the driving shaft in the end aperture of the tail section of the housing. The obtuse angle structure facilitates teeth cleaning operations by allowing the dental angle to easily reach all areas of the mouth and making practitioners feel more comfortable by allowing to maintain an ergonomically correct neutral wrist position and therefore reducing hand fatigue. A horseshoe-like snap retainer fits within the head section of the housing over the driven rotor to retain the rotor from coming out. A similar horseshoe-like snap retainer fits within the tail section of the housing over the driving shaft to retain the shaft firmly such that the gear of the driven rotor is always properly coupled to the matching gear of the driving shaft. The driving shaft transfers the rotation from a dental tool to the driven rotor for the purpose of tooth prophy using a cleaning cup.

### FIELD OF THE INVENTION

The present invention relates to a disposable dental appliance and more particularly to a dental prophylaxis angle (or “prophy angle”) used for cleaning teeth, and more especially to those to be disposed of after each patient to avoid cross infection.

### BACKGROUND OF THE INVENTION

A conventional prophy angle is used in dental treatment to remove plaque and to polish the surface of the enamel of teeth. A prophy cup is secured to the angle and is rotated by a drive mechanism, typically a gear drive. The prophy cup is shaped to retain a desired amount of prophy paste which is used to clean a patient's teeth.

A typical drive mechanism is a gear connection between a driving gear shaft and a driven gear rotor at a right angle of 90 degrees. The driving shaft is rotated by a dental drive means of a dental tool (such as a dental handpiece) with speeds typically ranging from 2,500 to 4,500 rpm. The rotation is transferred to the driven rotor by the gearing mechanism resulting in rotation of the attached prophy cup at an angle, conventionally at a right angle.

To improve the stability, performance and feel and hand fatigue of the operator, an operating angle other than 90 degrees has been studied by the disclosures of previous patents such as U.S. Pat. 2008/0064007, 2008/0003537, 2006/0127844, U.S. Pat. Nos. 6,916,176, 5,902,107, 5,749,728, 5,571,012, 5,531,599, 5,503,555, 5,433,605, 5,423,679, 5,374,189, 5,328,369, 5,074,788, 4,681,540, 4,460,337 and 4,382,790. However, in the present market, those products exhibit cost weakness or vibration/noise problem because of the complicated mechanical structure used to transfer the rotation.

Thus, the present invention provides a non-90-degree gear structure with features that ensure the driving gear remains properly engaged to the driven gear while reduce the hand fatigue of the dental practitioner during operation.

### BRIEF SUMMARY OF THE INVENTION

The invention is directed to a dental prophy angle that has an integrally formed housing, which incorporates two gears (driving gear and driven gear) and a removable prophylaxis head attachment, also called the prophylaxis cup (or “prophy cup”), and which translates rotation from a dental power source to the head attachment through these gears. More specifically, the driving gear shaft, which receives the dental power source on one end and engages with the driven gear on the other end, translates the rotation to the driven gear rotor at an angle. The entire prophy angle is made of plastic and is discarded after a single treatment, thus avoiding cross-contamination as well as the expense and inconvenience of sterilization.

One aspect of the invention is that the axes of the driving gear shaft and the driven gear rotor are not perpendicular to each other, facilitating teeth cleaning operations by allowing the prophy angle to easily reach all areas of the mouth and making practitioners feel more comfortable because the smaller bend in the body of the prophy angle allows them to maintain an ergonomically correct neutral wrist position to prevent the possible repetitive stress injuries, or cumulative micro trauma disorders, of the forearm, wrist and hand. The U.S. Government Bureau of Labor Statistics reported in 1994 that there were 92,576 cases annually involved days away from work due to repetitive motion and 55% affected the wrist.

Another aspect of prominent benefit of the present invention lies in the mating of the gears. Due to the necessary existence of operating tolerances in the sizing of the gears, there is some play in the gear contact. However, during operation, the inner contact engagement makes the mating of the gears closer as the driven rotor is pressed toward to the driving shaft by the force transmitted from the prophy cup.

A further aspect of the invention is a horseshoe-like positioner which acts as a driving shaft locking means. It consists of two forks perpendicular to the central axis of the tail-section passageway of the housing, where the separation gap between the forks is greater than the diameter of the driving shaft tail, and the horseshoe-like positioner is permanently located through a slot on the housing next to the shoulder of the driving shaft to ensure a secure assembly and to locate the driving shaft axially.

Similarly, the rotor head portion is held by another horseshoe-like retainer within the rotor neck to ensure that the rotor gear stays connected with the driving shaft gear head. The diameter of the rotor head is greater than the separation gap of the forks of the horseshoe-like driven rotor retainer to ensure that the rotor cannot come out, while the diameter of the rotor neck is smaller than the separation gap to ensure low operating friction and accurate rotation around the rotor axis during operation.

Thus, the arrangement of the horseshoe-like retainer provides a secure means for preventing the driven rotor from coming out while allowing it to rotate freely without much extra friction. Without it, the inner-side contact gearing arrangement would tend to eject the driven rotor from the housing because the gear on the driving shaft applies an outward force to the rotating driven gear.

Other details and features of the invention will be in part apparent and in part pointed out hereinafter.

### BRIEF DESCRIPTION OF THE DRAWINGS

The invention will be further described in conjunction with the attached drawings of which:

FIG. 1 is a perspective view of an assembled prophy angle, with 10—Housing, 20—Driving shaft, 30—Driven rotor, 40—Driving locker, 50—Driven retainer.

FIG. 2 is a cross-section view of the prophy angle shown in FIG. 1, 10—Housing, 20—Driving shaft, 21—Axis of driving shaft, 30—Driven rotor, 31—Axis of driven rotor, 40 —Driving locker, 50—Driven retainer, Angle α—an obtuse angle between the axis 21 of the driving shaft 20 and the axis 31 of the driven rotor 30.

FIG. 3 is a perspective view of the prophy angle prior to assembly, with 10—Housing, 20—Driving shaft, 30—Driven rotor, 40—Driving locker, 50—Driven retainer.

FIG. 4 is a perspective view of the driving shaft assembled with the driving shaft inside the housing, with 20—Driving shaft, 30—Driven rotor.

FIG. 5 is a perspective view of the driving shaft and driven rotor assembly with the driving locker and the driven retainer on, with 20—Driving shaft, 22—Driving gear, 23—Longitudinal positioning step, 30—Driven rotor, 32—Driven gear, 33—Rotor neck, 40 —Driving locker, 50—Driven retainer.

FIG. 6 is a perspective view of the driving locker, with 40—Driving locker, 41—Locker head, 42—Locker leg, 43—Locker hook.

FIG. 7 is a perspective view of the driven retainer, with 50—Driven retainer, 51—Retainer head, 52—Retainer leg, 53—Retainer hook.

### DETAILED DESCRIPTION OF THE INVENTION

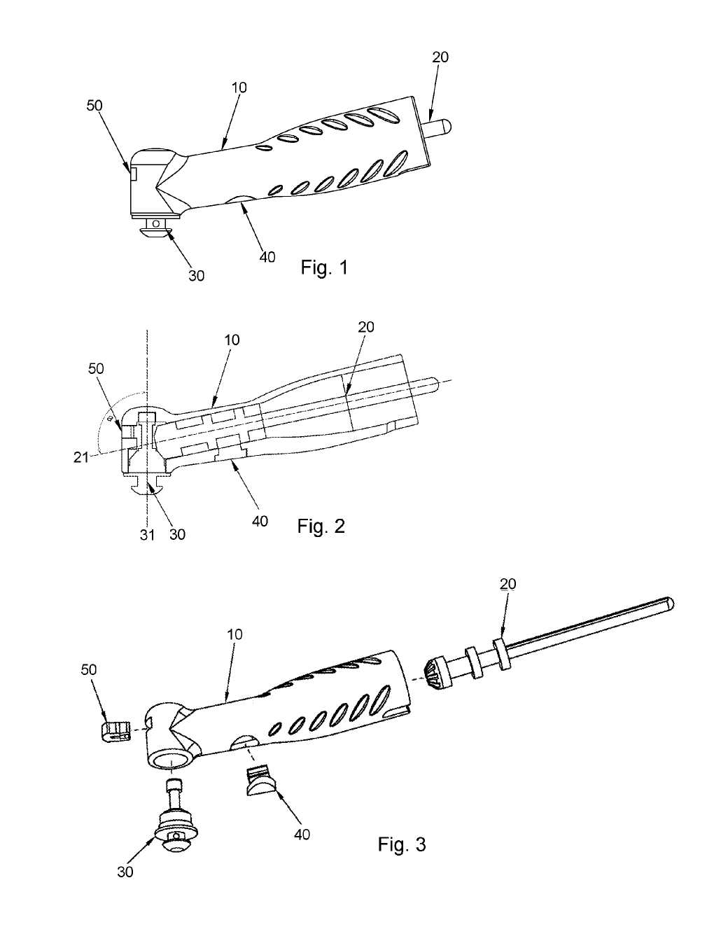

FIG. 1 and FIG. 2 show perspective and cross-sectional views of one preferred embodiment of the present invention. FIG. 3 shows a perspective view before assembly. The driving shaft 20 and driven rotor 30 are assembled inside of the housing 10 and positioned by the driving locker 40 and the driven retainer 50 correspondingly. The housing consists of a longitudinal tail section and a transverse head section and, as shown in FIG. 2, the angle a between the axis 21 of the driving shaft 20 and the axis 31 of the driven rotor 30 is slightly larger than the 90 degree angle found in most conventional prophy angles on the market. A powered dental handpiece of conventional type (not shown) is coupled to the tail of the driving shaft 20 and a snap-on rubber prophy cup with prophy paste (not shown) is connected to the cup holder head of the driven rotor 30.

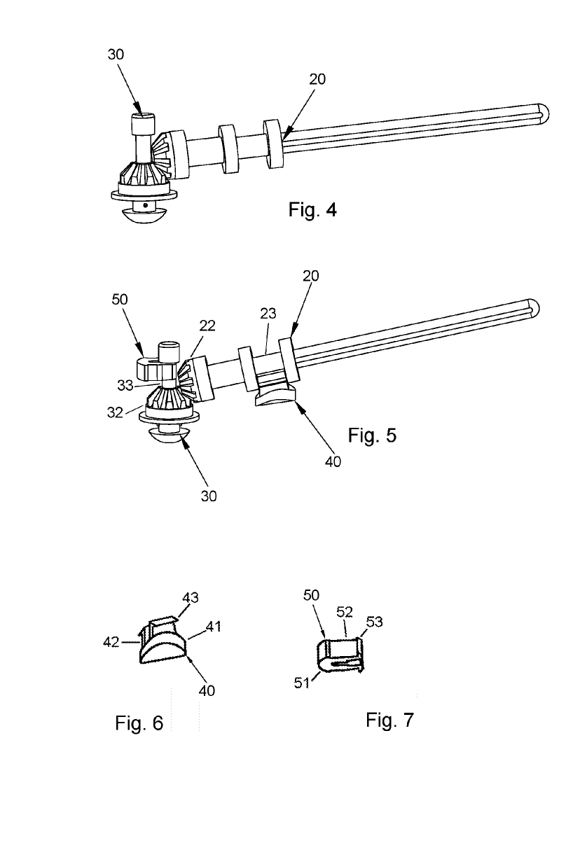

After assembly, the relative positions of the driving shaft 20 and the driven rotor 30 are shown in FIG. 4. The driving locker 40 and the driven retainer 50 are located on the driving shaft 20 and the driven rotor 30 respectively as shown in FIG. 5. When all the parts are assembled inside the housing the prophy angle is ready for operation as shown in FIG. 1.

The driving gear shaft 20 and the driven gear rotor 30 have tooth-matched gears that tranlate rotation of the driving gear shaft into rotation of the driven gear rotor. FIG. 4 shows that the axis of the translated rotation will be turned an angle larger than 90 degrees (referring to angle α in FIG. 2) to the source rotary unit because the axis of driven rotor 30 is not perpendicular to the axis of driving shaft 20.

FIG. 5 represents a more detailed perspective view of the assembled parts inside the housing. The driving gear 22 of the driving shaft 20 is positioned next to the driven gear 32 of the driven rotor 30 to ensure that the rotation is transferred between the driving shaft and the driven rotor properly. The driving shaft is locked in place by a horseshoe-like locker 40. This locking means provides a strong longitudinal backward-directed retaining force during operation of prophy angle. Axial movement of the driving shaft from its position relative to driven rotor is prevented once the driven gear rotor is in place. Similarly, the driven rotor 30 is maintained in an axial position by the driven rotor horseshoe-like retainer 50. The driven rotor retainer 50 holds the rotor neck 33 so that the rotor does not drop out during operation.

FIG. 6 represents a perspective view of the driving shaft locker 40. The horseshoe-like locker 40 is inserted through a hole in the wall of the longitudinal section of the housing 10. The left side of the locker forks 42 is located at the left side of the longitudinal positioning step 23 of the longitudinal section of the housing 10, providing a strong longitudinal, backward-directed retaining force during operation of the prophy angle. Transverse locking is achieved by a special structure on the locker forks 42. The structure consists of a locker hook 43 near the end of both locker forks, which ensures the transverse positioning of the locker 40. The locker forks 42 can be elastically bent. This combined with the fact that the fork depth is equal to the wall thickness of the housing 10 causes the locker 40 to snap into position when inserted into the hole in the housing 10. The locker hook 43 will stay against the inner wall of the housing, so that the locker 40 will not be forced out during operation. The head 41 of the locker 40 is constructed such that, when assembled, the edge of head 41 will rest against a step on the wall of the housing to have the outer surface of the locker 40 matched smoothly on the outer surface of the housing wall. The dimensions of horseshoe-like locker 40 are such that it avoids any contact with the surface of the shaft positioning step 23.

FIG. 7 represents a perspective view of the driven rotor retainer 50. The driven rotor retainer 50 maintains the positioning of the driven rotor 30 under any conditions which would tend to push it out of open end of transverse section of housing 10. The rotor neck 33 of driven rotor 30 is held firmly by the two driven rotor retainer forks 52. The driven rotor retainer 50 is inserted through the driven rotor retainer slot in the wall of the transverse section of housing 10. A retaining hook 53 exists on the tip of each retainer fork 52. The two retaining forks 52 can be elastically bent, as with the locker forks 42, so that when the driven rotor retainer 50 is inserted into the housing 10, it snaps into position. The retaining hooks 53 ensure that the driven rotor 50 cannot be forced out under any circumstances. The dimensions of the structure ensure that the driven rotor retainer 50 cannot touch any part of the driven rotor 30 other than the rotor neck 33. The shape of the curved head 51 of the driven rotor retainer 50 matches the shape of the driven rotor retainer slot on the wall of the transverse section of the housing 10.

In view of the above, it will be seen that the objects of the invention are achieved.

Although specific examples of the present invention and its application are set forth herein, they are not intended to be exhaustive or limiting of the invention. These illustrations and explanations are intended to acquaint others skilled in the art with the invention, its principles, and its practical application, so that others skilled in the art may adapt and apply the invention in its numerous forms, as may best suit the requirements of a particular use.

We claim:

1. A disposable dental prophylaxis angle comprising:
a driving shaft including a gear, a positioning step and a shaft tail;
a driven rotor including a rotor head, a rotor neck, a gear, a cup flange, a cup neck, and a cup holder;
a housing including a longitudinal and a transverse section in one integral piece;
means for coupling said driving shaft in said longitudinal section of said housing to said driven rotor in said transverse section of said housing so as to maintain continuous engagement of driving and driven gears during operation.

2. The dental prophylaxis angle of claim 1, wherein said driving shaft is positioned so as to permit coupling of its tail to a dental drive means of a dental tool, thereby transferring rotation to said gear of said driving shaft through the rear end of said shaft tail.

3. The dental prophylaxis angle of claim 1, wherein said driven rotor is positioned so as to permit coupling of said driven rotor to a prophy cup at the bottom end of said driven rotor.

4. The dental prophylaxis angle of claim 1, wherein said driving shaft is connected to said driven rotor by a gear connection, said driving shaft being at an obtuse angle, preferably 100 to 105 degrees, with respect to said rotor axis, to facilitate teeth cleaning operations by allowing said dental prophylaxis angle to easily reach all areas of the mouth and making practitioners feel more comfortable by maintaining an ergonomically correct neutral wrist position.

5. The dental prophylaxis angle of claim 2, wherein said driving shaft locking means comprises a horseshoe-like positioner, said horseshoe-like positioner having two forks perpendicular to the central axis of the longitudinal section of said housing, with the separation gap between said forks being greater than the diameter of said driving shaft tail, and said horseshoe-like positioner being permanently located through a slot on said housing, riding on a longitudinal positioning step of said driving shaft to ensure a secure assembly to axially locate said driving shaft.

6. The dental prophylaxis angle of claim 3, wherein said rotor neck is held in position by said horseshoe-like driven rotor retainer to ensure that said rotor gear stays connected with said shaft gear, with the diameter of said rotor head being greater than the separation gap of the forks of said horseshoe-like driven rotor retainer to prevent withdrawal of said driven rotor, and the diameter of said rotor neck being smaller than the separation of the forks of said horseshoe-like driven rotor retainer to ensure low operating friction and accurate rotation around its axis during operation.
